(19) United States
(12) Patent Application Publication
(10) Pub. No.: US 2010/0291787 A1
(43) Pub. Date: Nov. 18, 2010

(54) Electrical Connector

(76) Inventor: Chih Cheng Kuo, Taipei (TW)

Correspondence Address: BARLEY SNYDER, LLC, 1000 WESTLAKES DRIVE, SUITE 275, BERWYN, PA, 19312, US

(21) Appl. No.: 12/778,741

(22) Filed: May 12, 2010

(30) Foreign Application Priority Data
May 12, 2009 (TW) 98208132

(51) Int. Cl. H01R 13/62

(52) U.S. Cl. 439/352

(57) ABSTRACT

An electrical connector having a socket, a latch rod, a plug, and a pulling mechanism. The socket includes a slot, with the latch rod connecting to the socket. The plug includes a lock on each of opposite side walls, with the plug insertable into the slot. The latch rod is rotatable and receivable in the lock. The pulling mechanism is located on the plug, with the latch rod being pressable on the pulling mechanism to secure it. The pulling mechanism enables the latch rod to be easily released from the lock.

### CROSS-REFERENCE TO RELATED APPLICATIONS

This application claims priority under 35 U.S.C. § 119 to Taiwan Utility Model Application No. 98208132, filed May 12, 2009.

### FIELD OF THE INVENTION

The present invention relates to an electrical connector, and more particularly, to an electrical connector having a latch rod which protects a pulling mechanism and secures the electrical connector during connection.

### BACKGROUND

As technology advances, various types of electronic products are being developed to meet consumer needs. In order for these products to achieve high performance, it is an essential requirement to provide increased stability to the electronic products. The standard for electronic component stability is rising to meet the demands of higher performance of electronic product, as well as diversified user environment. Connectors serve as a medium to connect and transport signals between different electronic components, and hence, the stability of connectors plays a key role in the performance of electronic components; moreover, how to make the assembly and maintenance of connectors easier is also an important issue.

Referring to FIG. 8, an existing connector 20 is shown, having a socket 21 with a slot (not shown), a plug 22 inserted in the slot of the socket 21, and a pulling mechanism 23 provided on a side wall 24 of the plug 22. The user pulls the pulling mechanism 23 to disconnect the plug 22 from the socket 21.

Taiwan Patent Publication No. 1287325 disclosed a connector for connection with a mating connector. The connector includes a contact, a housing holding the contact, an operating member coupled to the housing to bring a part of the connection object into press contact with the contact, and a locking member for clamping the other part of the connection object in cooperation with the operating member.

The disadvantage of this existing connector lies in that no protective cover or shield is provided to protect the pulling mechanism, and this may easily cause deformation or damage to the pulling mechanism. Therefore, there is a need to overcome this drawback of a conventional connector.

### SUMMARY OF THE INVENTION

An aspect of the present invention is to provide an electrical connector provided having a latch rod on a socket and a lock on a plug. The latch rod is received in the lock in order to secure coupling between the plug and the socket. Furthermore, the latch rod protects a pulling mechanism of the plug, which enables the latch rod to be easily released from the lock, from being damaged.

The electrical connector includes a socket, a latch rod, a plug, and a pulling mechanism. The socket includes a slot, with the latch rod connecting to the socket. The plug includes a lock on each of opposite side walls, with the plug insertable into the slot. The latch rod is rotatable and receivable in the lock. The pulling mechanism is located on the plug, with the latch rod being pressable on the pulling mechanism to secure it. The pulling mechanism enables the latch rod to be easily released from the lock

### BRIEF DESCRIPTION OF THE DRAWINGS

The invention will be explained in greater detail below with reference to Figures and exemplary embodiments, without the general concept of the invention being limited.

FIG. 1 is a exploded view of an electrical connector according to the present invention;

FIG. 2 is another exploded view of the electrical connector according to the present invention;

FIG. 3 is a first assembly drawing of the electrical connector according to the present invention;

FIG. 4 is a second assembly drawing of the electrical connector according to the present invention;

FIG. 5 is a third assembly drawing of the electrical connector according to the present invention;

FIG. 6 is a fourth assembly drawing of the electrical connector according to the present invention;

FIG. 7 is another exploded view of the electrical connector according to the present invention; and

FIG. 8 is a perspective view of an known connector.

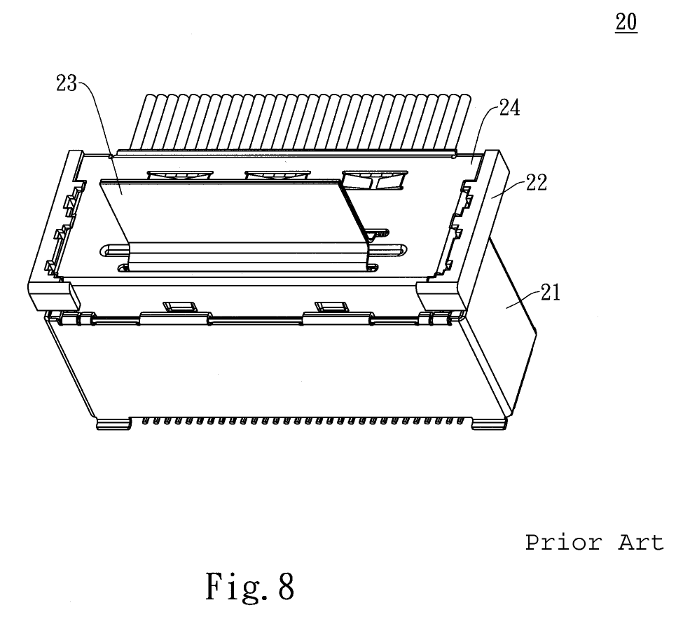

### DETAILED DESCRIPTION OF THE EMBODIMENT(S)

The present invention will now be described more fully hereinafter with reference to the accompanying drawings, in which embodiments of the invention are shown. It is to be understood that all kinds of alterations and changes can be made by those skilled in the art without deviating from the spirit and the scope of the invention. This description is not to be taken in a limiting sense, but is made for the purpose of illustrating the general principles of the invention.

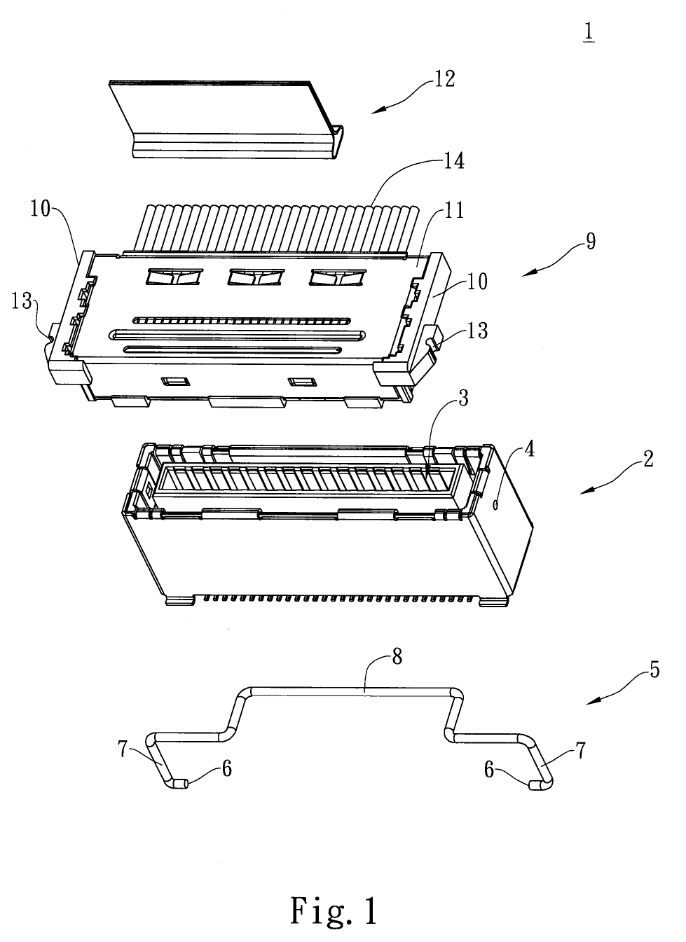

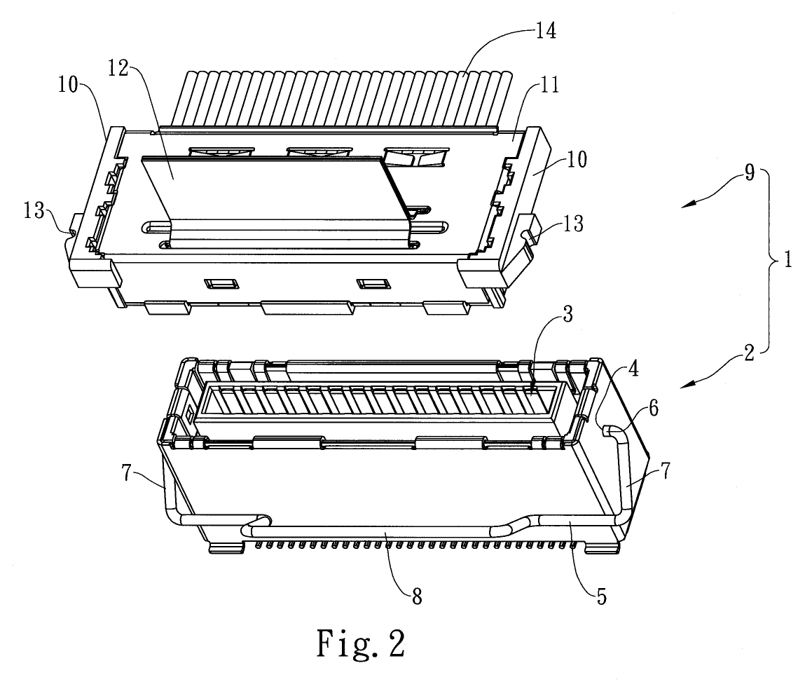

Referring to FIGS. 1 and 2, an electrical connector 1, according to the invention, is shown having a socket 2 with a slot 3, a latch rod 5, a plug 9, and a pulling mechanism 12. The socket 2 includes a hole 4 on each of its opposite side walls. The latch rod 5 includes a pair of end portions 6, a pair of arm portions 7 and a central portion 8. The plug 9 includes a plurality of side walls 10, 11 and a lock 13 on each side wall 10, one end of the plug 9 being connected to a cable 14 and the other end of the plug 9 being inserted into the slot 3 to be electrically connected to contacts within the socket 2. The pulling mechanism 12 is provided on the side wall 11 of the plug 9.

The end portions 6 of the latch rod 5 protrude through the holes 4 of the socket 2 to be fitted therein, and the central portion 8 of the latch rod 5 is formed in a reverse U-shape.

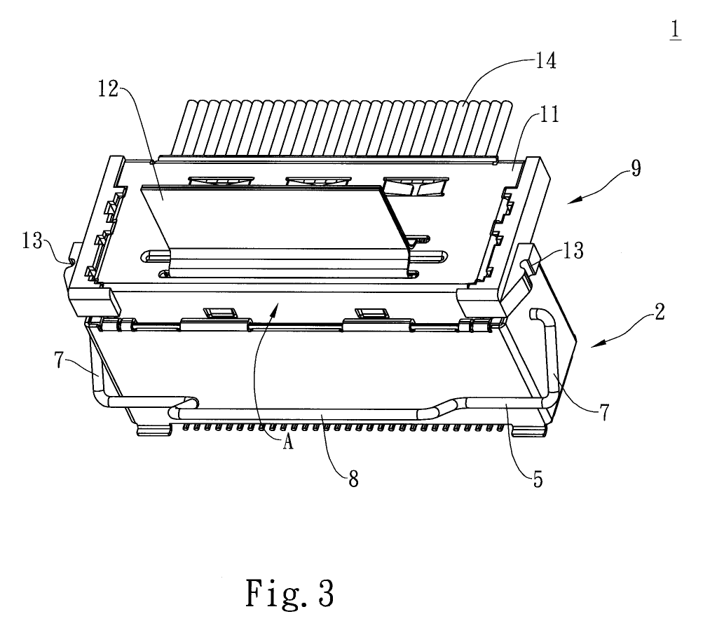

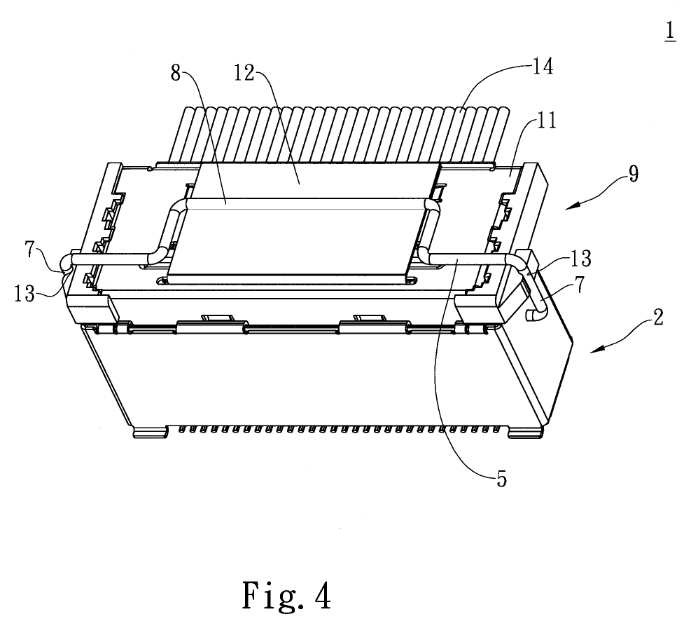

Referring to FIGS. 3 and 4, the plug 9 is inserted into the slot 3 of the socket 2, during assembly. Then, the latch rod 5 is rotated in the direction of arrow A as shown in FIG. 3, so that the arm portions 7 of the latch rod 5 are received in the locks 13 of the plug 9 and the central portion 8 of the latch rod 5 presses the pulling mechanism 12 down. As a result, the pulling mechanism 12 will press closely on the side wall 11 of the plug 9, and the electrical connection between the contacts in the socket 2 and the cable 14 at one end of the plug 3 is secured.

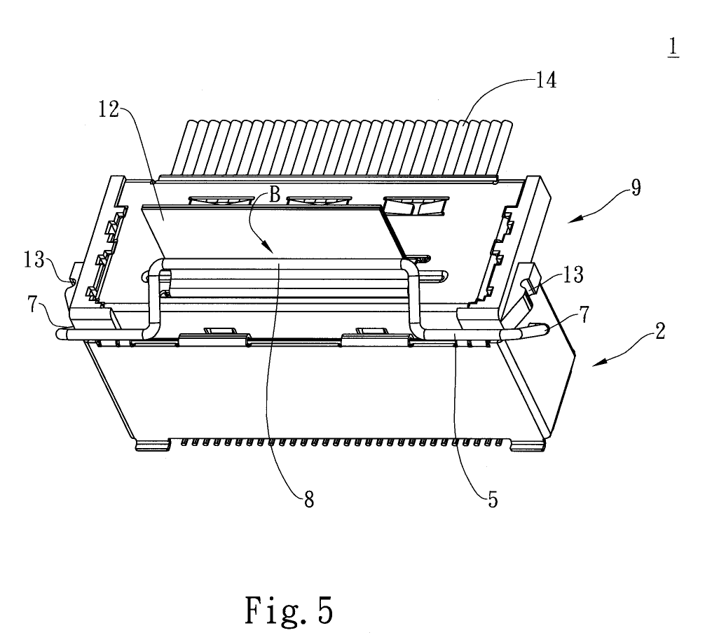

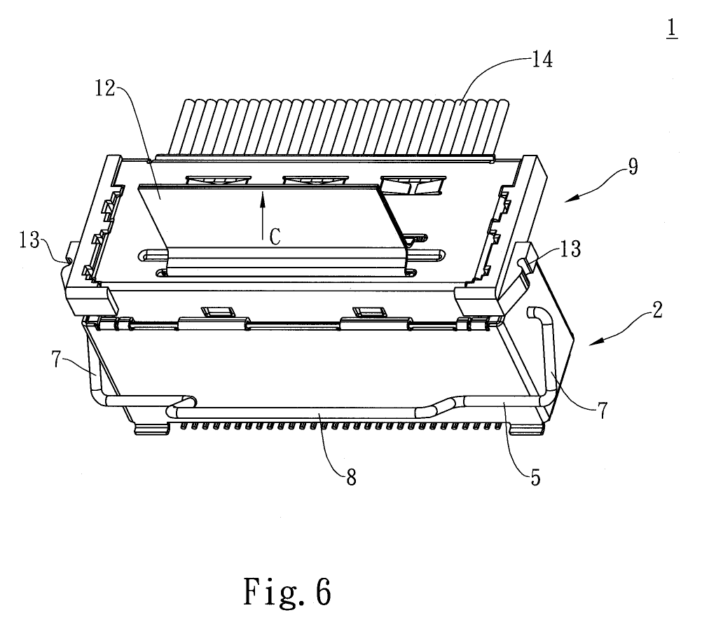

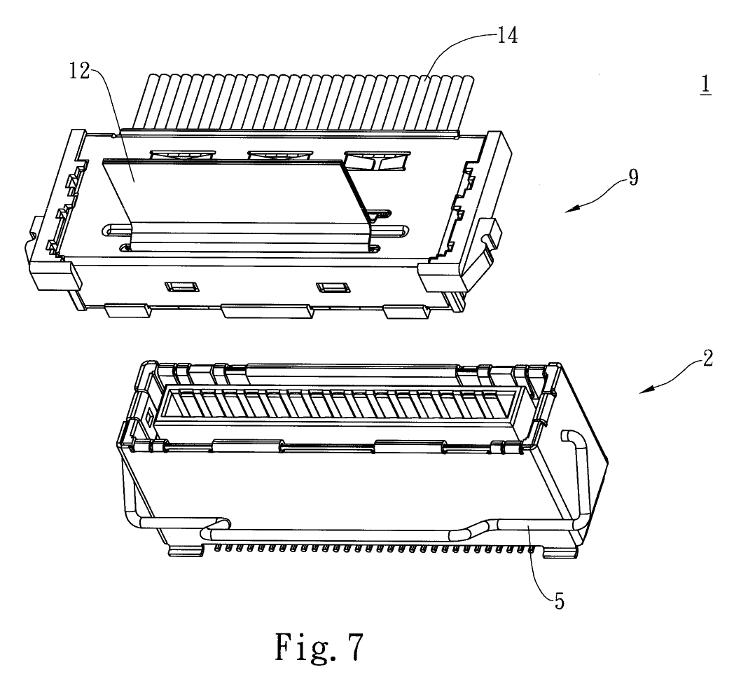

Referring to FIGS. 5 and 6, further assembly is shown, where the pulling mechanism 12 is pulled away from the side wall 11 and then rotated in the direction of arrow B as by the user (see FIG. 5). As a result, the latch rod 5 will spontaneously rotate together with the latch rod 12, and the arm portions 7 of the latch rod 5 are released from the locks 13 of the plug 9. Afterwards, when the pulling mechanism 12 is pulled upward by the user in the direction of arrow C, as shown in FIG. 6, the plug 9 and the socket 2 will be electrically disconnected(see FIG. 7).

An electrical connector according to the present invention has several advantages. When the latch rod 5 presses the pulling mechanism 12 down to make it press closely on the side wall 11 of the plug 9, the latch rod 5 can protect the pulling mechanism 12 from being damaged. Additionally, the latch rod 5 can firmly secure the coupling between the plug 9 and the socket 2 when the arm portions 7 of the latch rod 5 are received in the locks 13 of the plug 9. Furthermore, the arm portions 7 of the latch rod 5 can be easily released from the locks 13 of the plug 9 when the pulling mechanism 12 is rotated by the user, such that the latch rod 5 can spontaneously rotate together with the pulling mechanism 12.

While this invention has been described by way of examples and in terms of the embodiments, it is to be understood that this invention is not limited hereto, and that various changes and modifications can be made by those skilled in the art without departing from the spirit and scope of this invention. It is intended that the scope of the invention be defined by the claims appended hereto.

What is claimed is:

1. An electrical connector, comprising:
a socket having a slot;
a latch rod connected to the socket;
a plug having a lock on each of opposite side walls and rotatably receiving the latch rod, the plug being insertable into the slot; and
a pulling mechanism located on the plug with the latch rod being pressable on the pulling mechanism to secure the pulling mechanism;
wherein the pulling mechanism enables the latch rod to be easily released from the lock.

2. The electrical connector according to claim 1, wherein the socket includes a hole on each side wall corresponding to the lock of the plug.

3. The electrical connector according to claim 2, wherein the latch rod includes a pair of end portions being received in each hole.

4. The electrical connector according to claim 3, wherein the latch rod includes a pair of arm portions.

5. The electrical connector according to claim 4, wherein the latch rod includes a central portion.

6. The electrical connector according to claim 5, wherein the central portion of the latch rod is formed in a reverse U-shape.

7. An electrical connector comprising:
a latch rod connected to two opposite surfaces thereof;
a pulling mechanism of a mating electrical connector being protected and locked by the latch rod after coupling;
wherein the pulling mechanism is pressable onto the mating electrical connector by the latch rod, the latch rod being releasable by the pulling mechanism.

8. The electrical connector according to claim 7, wherein the mating electrical connector is connected to a plurality of cables.

9. The electrical connector according to claim 7, wherein the latch rod is pivotally connected to the two opposite surfaces of the electrical connector.

10. The electrical connector according to claim 9, wherein the latch rod is receivable in a lock of the mating electrical connector having the pulling mechanism.
